(19) United States
(12) Patent Application Publication
(10) Pub. No.: US 2003/0034364 A1
(43) Pub. Date: Feb. 20, 2003

(54) Container with sealing device

(76) Inventor: Jan Mugge, Drachten (NL)

Correspondence Address: Michael E. Marion, c/o U.S. Philips Corporation, Intellectual Property Department,, 580 White Plains Road, Tarrytown, NY, 10591, US

(21) Appl. No.: 10/217,823

(22) Filed: Aug. 12, 2002

(30) Foreign Application Priority Data
Aug. 16, 2001 (EP) 01203118.3

(51) Int. Cl. B67D 3/00

(52) U.S. Cl. 222/518

(57) ABSTRACT

The invention relates to a container (1) comprising a sealing device (4) which has an outlet opening, a valve (8), and a seat (7) for cooperation with said valve (8), the valve (8) being movable by means of a fluid conduit (12) with respect to the seat (7) from a first position (I), in which the valve (8) rests against the seat (7) so as to close the container (1), into a second position (II), in which the valve (8) is free from the seat (7) so as to open the container, wherein resilient means (18) are provided for exerting a force on the valve (8) in at least a direction from the second position (II) to the first position (I) of the valve (8). The resilient means (18) close the valve (8) again by means of a resilient force in a direction from the second position to the first position of the valve (8). The container can thus be sealed in a reliable and efficient manner.

The invention relates to a container comprising a sealing device which comprises an outlet opening, a valve, and a seat for cooperation with said valve, the valve being movable by means of a fluid conduit with respect to the seat from a first position, in which the valve rests against the seat so as to close the container, into a second position, in which the valve is free from the seat so as to open the container.

A container of the type defined in the opening paragraph is known from WO 98/48203. In the known container, the sealing device comprises a valve for cooperation with a seat. Said valve is movable with respect to the seat by insertion of a fluid conduit from a first position, in which the valve is in contact with the seat by means of a first snap coupling and the container is closed, into a second position, in which the valve is free from the seat and the container is open. To open the valve of this known container, the fluid conduit has to be pushed against the valve in a first direction so as to move the valve until the first snap coupling is released. The valve is then free from the seat and the container is opened. The fluid conduit has to be pushed further to engage a second snap coupling between the fluid conduit and the valve for the purpose of closing the container again later by moving the fluid conduit and the valve together in a second direction opposed to the first direction. After a transfer of the contents of the container to the outside or vice versa, the fluid conduit has to be pulled in the second direction opposed to the first direction. The movement of the fluid conduit in the second direction causes the valve to engage the first snap coupling again, closing the container, and after that causes the second snap coupling between the fluid conduit and the valve to be released.

A disadvantage of the known container is that it does not offer a reliable operation. When the fluid conduit is moved in the second direction taking along the valve, the second snap coupling between the fluid conduit and the valve is liable to be released while the first snap coupling between the valve and the seat has not been engaged yet. A user then thinks the container is closed, since he notices that the fluid conduit has been released from the valve, whereas in fact the valve is not yet correctly engaged with the first snap coupling and the container is thus not yet closed. In this way, the contents may leak from the container. A further drawback is that the contents are exposed to the open air, which causes them to dry up within the container.

It is an object of the invention to provide a container as defined in the opening paragraph which offers a reliable operation. To achieve this object, a container according to the invention is characterized in that resilient means are provided for exerting a force on the valve in at least a direction from the second position to the first position of the valve. During operation the fluid conduit exerts a force on the valve and moves it from the first position into the second position, thus creating a passage for the contents to pass into or out of the container. The resilient means close the valve again by means of a resilient force in a direction from the second position to the first position of the valve, in which the valve is closed and the passage for the contents is sealed. In this manner the container can be sealed in a reliable and efficient way.

An embodiment of a container according to the invention is characterized in that the resilient means comprise a spring element provided in the vicinity of the valve. In this manner a relatively simple and cost-effective construction of the resilient means is realized.

A further embodiment of a container according to the invention is characterized in that the fluid conduit is movably mounted in the sealing device. In this manner the container is especially suitable for use as a container for the leakproof refilling of reservoirs, for example additive reservoirs in hair stylers. These reservoirs comprise an opening for cooperation with one end of the fluid conduit. When one end of the fluid conduit is inserted into the opening of the reservoir to be refilled, the fluid conduit is moved within the sealing device of the container in the direction of the valve. A force is then exerted by the other end of the fluid conduit on the valve to open it, and the contents of the container can pass the valve and be transported through the fluid conduit into the reservoir. When the one end of the fluid conduit is withdrawn from the reservoir, its other end is withdrawn from the valve and the resilient means urge the valve back into its closed position.

A further embodiment of a container according to the invention is characterized in that the seat comprises an elongate element having a cross-section, and that the valve comprises an elastically deformable disc arranged around said element and comprising an opening having a cross-section corresponding to the cross-section of the elongate element, while an inner rim, which bounds said opening, rests against the element in the first position, and said inner rim lies clear of the element through elastic deformation of the disc in the second position. In the first position, the inner rim of the disc fits tightly around the elongate element due to the flexible material of the disc. During operation the fluid conduit is placed around the element, and its walls exert a force on the inner rim of the valve. This causes the disc to deform elastically and causes said rim to be disengaged from the element, whereby the valve is opened. When the fluid conduit is withdrawn, the inner rim returns to its first position under the influence of the resilient force exerted on the disc and engages the element again, thus sealing the container.

It is advantageous in this embodiment when the spring element is mounted around the elongate element for acting on a central portion of the disc comprising said opening. A convenient and space-saving arrangement of the resilient means is realized in this manner.

A further embodiment of a container according to the invention is characterized in that the opening is circular, and the fluid conduit comprises a tube having a conical end portion for cooperation with the inner rim of the opening. Because of its conical end portion, the tube can be easily engaged with the inner rim of the opening in the disc for freeing the inner rim from the elongate element, and the outer area of the conical end portion will clearly indicate the end of the movement.

A further embodiment of a container according to the invention is characterized in that an additional opening is provided in the sealing device, which opening is closed by an outer portion of the disc and is opened by an elastic deformation of the outer portion of the disc under the influence of an underpressure in the container. During operation an underpressure will arise in the container as a result of the contents of the container being removed from it. The underpressure in the container causes the outer portion of the disc to be elastically deformed, and the additional opening is opened. Air is drawn into the container via the opening to restore the pressure within the container, and the additional opening is closed again by the resilient force in the outer portion. The valve for sealing the container is thus also used as part of an air vent for the container.

The invention will be described in more detail hereinafter with reference to the drawings, in which

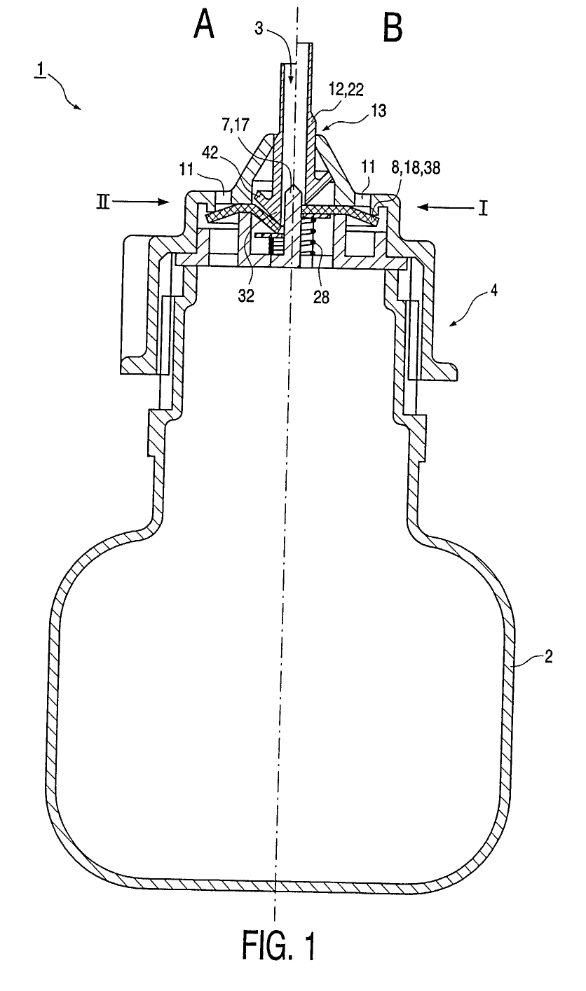

FIG. 1 is a diagrammatic cross-section of a first embodiment of a container according to the invention, the left portion showing the container in its opened position, the right portion showing the container in its closed position,

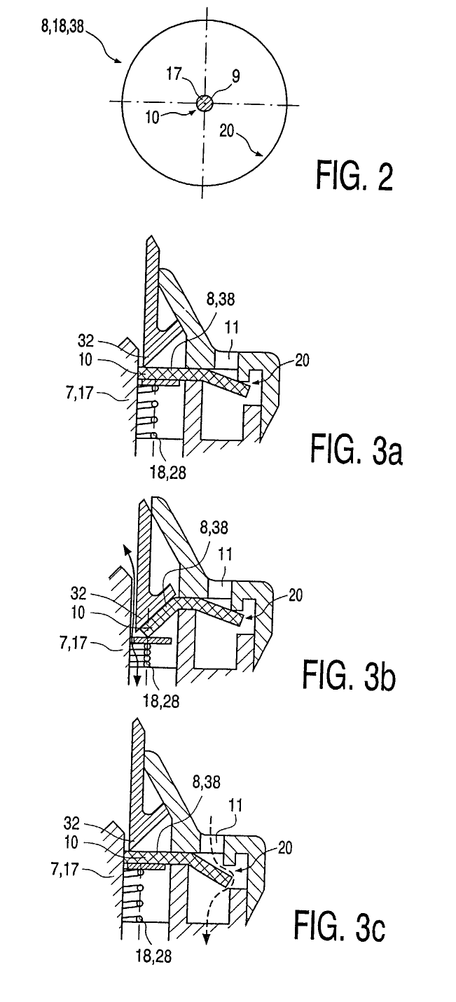

FIG. 2 shows a valve and a valve seat of the first embodiment of the container of FIG. 1 viewed from above, and

FIGS. 3a, 3b and 3c show in further detail a valve and a valve seat of the first embodiment of the container of FIG. 1, in various positions during operation.

FIG. 1 shows a first embodiment of a container 1 according to the invention, comprising a sealing device 4 which comprises an outlet opening 3, a valve 8, and a seat 7 for cooperation with said valve 8. The valve 8 is movable with respect to the seat 7 by means of a fluid conduit 12 from a first position I as shown in part B of the Figure, in which the valve 8 rests against the seat 7 so as to close the container 1, into a second position II as shown in part A of the Figure, in which the valve 8 lies clear of the seat 7 so as to open the container 1. The fluid conduit 12 is movably mounted in the sealing device 4, the fluid conduit 12 being arranged with sliding possibility within an opening 13 in the sealing device 4 and having a rim 42 for limiting the movement of the conduit 12 through abutment against the walls of the opening 13. This embodiment of a container according to the invention may be advantageously used for filling other reservoirs with contents of the container. The fluid conduit 12 can be easily connected to an additive reservoir comprising an opening for receiving an end of the fluid conduit, for example a refill bottle for refilling an additive reservoir of a hair styler. The container itself is capable of being filled with the contents of another container or the like when the complete sealing device 4 is removed.

In this embodiment, the seat 7 comprises an elongate element 17 having a cross-section, and the valve 8 comprises an elastically deformable disc 38 arranged around said element 17 and comprising an opening 9 having a cross-section corresponding to the cross-section of the elongate element 17, as can be seen in FIG. 2. The disc 38 is at least partly made from an elastically deformable material, in this embodiment a rubber compound. It is to be understood that other known types of elastically deformable materials are also applicable. As is shown in FIG. 2, an inner rim 10 bounding the opening 9 fits tightly around the element 17 owing to the elasticity of the material of the disc 38. In the first position I as shown in part B of the Figure, the fluid conduit 12 does not exert a force on the disc 38. In the second position II as shown in part A of the Figure, the fluid conduit 12 does exert a force on the disc 38, which causes said inner rim 10 to lie clear of the element 17 through elastic deformation of the disc 38. As may also be seen in FIG. 1, a spring element 28 is provided in the vicinity of the disc 38. The spring element 28 is mounted around the elongated element 17 for operating on the central portion of the disc in this embodiment. The spring element is thus able to exert a force on one side of the disc 38 in the location where the fluid conduit 12 exerts a force on the opposite side of the disc to open the container. As can be seen in FIG. 2, the central opening has a circular cross-section. The fluid conduit 12 furthermore comprises a tube 22 having a conical end portion 32 for cooperation with the inner rim 10 of the opening 9. Part A of FIG. 1 shows the conical end portion 32 of the fluid conduit 22 in cooperation with the inner rim 10, by means of which the disc 38 is elastically deformed and the inner rim 10 of the disc 38 is freed from the element 17 in an easy manner to open the container 1.

FIG. 3a shows a detail of the first embodiment of the container, in which the disc 38 is in the first position I as shown in part B of FIG. 1. In this position, the inner rim 10 rests against the element 17. FIG. 3b shows the disc 38 in the second position II, when the fluid conduit exerts a force on said disc so as to free the inner rim 10 from the element 17 and to open the container 1. Additive can thus flow from the container into another reservoir, or vice versa, as indicated with the arrow in FIG. 3b. When the fluid conduit is withdrawn from the disc 38, the elastic forces of the disc 38 and the spring element 28 urge the inner rim of the disc 38 back into its first position I to rest against the element 17, as indicated in FIG. 3a.

As can be seen in FIG. 1, furthermore, an additional opening 11 is provided in the sealing device 4, which opening is closed by an outer portion 20 of the disc. FIG. 3c shows the disc in a further position in which the inner rim 10 rests against the element 17, and said opening 11 is opened through elastic deformation of the outer portion 20 of the disc 38 under the influence of an underpressure in the container 1. The underpressure will arise if the bottle is squeezable and returns to its original shape after being squeezed. The underpressure in the container 1 causes the outer portion 20 of the disc 38 to be elastically deformed, and the additional opening is opened, as shown in FIG. 3c. Air is drawn into the container via the opening, indicated with the dotted arrow in FIG. 3c, until the pressure within the container is restored and the outer portion 20 closes the additional opening 11 again. The disc 38 thus fulfills a double function: it is used for sealing the container 1, and it is used as part of an air vent for the container 1. It is to be understood that the sealing device 4 may comprise one or a plurality of openings 11, which may differ in shape and size.

It is noted that a container according to the invention, in which resilient means 18 are provided for exerting a force on the valve 8 in at least a direction from the second position to the first position of the valve 8, offers a reliable operation. The resilient means close the valve in a convenient and effective manner by means of a resilient force in a direction from the second position to the first position of the valve, in which the valve is closed and the passage for the contents is sealed.

It is furthermore noted that the container may be used as a refill container for filling other reservoirs. Such a reservoir could be, for example, an additive reservoir provided in a personal care device which applies additive during operation. Such personal care devices are, for example, a hair styler with a reservoir for water or hair conditioner, a shaver with a reservoir for shaving balm, or a toothbrush with a reservoir for toothpaste or the like. However, it is observed that other devices comprising a reservoir for additive may also be refilled in an advantageous manner from a container according to the invention.

It is advantageous in this case if the fluid conduit forms part of the container itself, as in the embodiment of FIG. 1, so that an end of the fluid conduit can be easily connected to an opening in the additive reservoir provided on the device.

1. A container (1) comprising a sealing device (4) which comprises an outlet opening, a valve (8), and a seat (7) for cooperation with said valve (8), the valve (8) being movable by means of a fluid conduit (12) with respect to the seat (7) from a first position (I), in which the valve (8) rests against the seat (7) so as to close the container (1), into a second position (II), in which the valve (8) is free from the seat (7) so as to open the container, characterized in that resilient means (18) are provided for exerting a force on the valve (8) in at least a direction from the second position (II) to the first position (I) of the valve (8).

2. A container as claimed in claim 1, characterized in that the resilient means (18) comprise a spring element (28) provided in the vicinity of the valve (8).

3. A container as claimed in claim 1, characterized in that the fluid conduit (12) is movably mounted in the sealing device (4).

4. A container as claimed in claim 1, characterized in that the seat (7) comprises an elongate element (17) having a cross-section, and that the valve (8) comprises an elastically deformable disc (38) arranged around said element and comprising an opening (9) having a cross-section corresponding to the cross-section of the elongate element, while an inner rim (10), which bounds said opening (9), rests against the element (17) in the first position, and said inner rim (10) lies clear of the element (17) through elastic deformation of the disc (38) in the second position.

5. A container as claimed in claim 2 and 4, characterized in that the spring element (28) is mounted around the elongate element (17) for acting on a central portion of the disc (38) comprising said opening (9).

6. A container as claimed in claim 3 and 4, characterized in that the opening (9) is circular, and the fluid conduit (12) comprises a tube (22) having a conical end portion (32) for cooperation with the inner rim (10) of the opening (9).

7. A container as claimed in claim 4, characterized in that an additional opening (11) is provided in the sealing device (4), which opening is closed by an outer portion (20) of the disc (38) and is opened by an elastic deformation of the outer portion (20) of the disc (38) under influence of an underpressure in the container (1).
